(19) United States
(12) Patent Application Publication
(10) Pub. No.: US 2014/0117131 A1
(43) Pub. Date: May 1, 2014

(54) CENTRIFUGAL BALL MILL

(71) Applicant: DENSO CORPORATION, Kariya-city (JP)

(72) Inventors: Norio GOUKO, Kariya-shi (JP); Atusi SAKAIDA, Nagoya (JP); Tomikazu ISHIKAWA, Kariya-shi (JP); Keiji OKAMOTO, Kariya-shi (JP); Yoshihiko SHIRAISHI, Nagoya (JP)

(21) Appl. No.: 14/064,808

(22) Filed: Oct. 28, 2013

(30) Foreign Application Priority Data
Oct. 31, 2012 (JP) 2012-240027
Dec. 26, 2012 (JP) 2012-283152

(51) Int. Cl. B02C 17/08

(52) U.S. Cl. CPC B02C 17/08
USPC 241/175

(57) ABSTRACT

A centrifugal ball mill has a cylindrical container in which an object to be crushed and a crushing ball are contained, a revolution mechanism that revolves the container about a revolution axis, and a rotation mechanism that rotates the container about a rotation axis. Furthermore, the centrifugal ball mill has an inclination mechanism that inclines an inner periphery face relative to the rotation axis such that a position where centrifugal force acting due to revolution about the revolution axis is maximum in the inner periphery face changes in an axial direction of the container as the container rotates about the rotation axis, and such that the crushing ball moves in a circumferential direction and the axial direction of the container to describe a trajectory of a three dimensional Lissajous curve.

### CROSS-REFERENCE TO RELATED APPLICATION

This application is based on and claims the benefit of priority from earlier Japanese Patent Application No. 2012-240027 filed Oct. 31, 2012, and earlier Japanese Patent Application No. 2012-283152 filed Dec. 26, 2012, the description of which is incorporated herein by reference.

### BACKGROUND OF THE INVENTION

1. Technical Field of the Invention

The present invention relates to a centrifugal ball mill which revolves and rotates a container containing an object and a crushing ball for crushing the object.

2. Related Art

Conventionally, a centrifugal ball mill which revolves a container containing crushing balls and objects to be crushed about a revolution axis and rotates the container about a rotation axis is known. As an example of centrifugal ball mills, the patent document 1 (Japanese Patent Publication No. 2006-43578) discloses a centrifugal ball mill in which its rotation axis is inclined to its revolution axis. In the patent document 1, it is described that the configuration causes tornado movement of the crushing balls and the objects, and that this increases crushing efficiency.

### SUMMARY

The present inventers have found that crushing balls are likely to gather to constant sites in containers when conventional centrifugal ball mills revolve and rotate.

For example, according to the patent document 1, the rotation axis is inclined to the revolution axis, and a center axis of a cylindrical container is parallel to the rotation axis, therefore, the center axis of the container is inclined to the revolution axis, and the inner periphery face of the container is also inclined to the revolution axis.

Therefore, distance between the revolution axis and the inner periphery face of the container is different between ends of the axial direction of the container. As a result, the magnitude of the centrifugal force due to the revolution is different between ends of the axial direction of the container. In other words, in the inner periphery face, the position (described below as a maximum centrifugal force position) where the centrifugal force due to the revolution is maximum in the inner periphery face occurs. Then, the crushing balls gather to the maximum centrifugal force position in the inner periphery face of the container.

In the patent document 1, the center axis of the container is parallel to the rotation axis. Therefore, even if the container rotates about the rotation axis, the inclination angle of the center axis of the container to the revolution axis does not change and is kept constant, and the inclination angle of the inner periphery face of the container to the revolution axis does not change and is kept constant.

Therefore, even if the container rotates, the part farthest away from the revolution axis in the inner periphery face does not change along the axial direction of the container, as a result, the maximum centrifugal force position in the inner periphery face does not change along the axial direction of the container.

As a result, the crushing balls gather to the constant part of the axial direction of the container in the inner periphery of the container. Therefore, there is a problem that a force for agitating the crushing balls in the axial direction of the container is difficult to obtain, then that effect of improving the crushability is poor.

It is thus desired to provide a centrifugal ball mill that can solve the problem of crushing balls gathering and improve crushability.

An exemplary embodiment provides a centrifugal mill has a cylindrical container in which an object to be crushed and a crushing ball are contained, a revolution means for revolving the container about a revolution axis, a rotation means for rotating the container about a rotation axis, and an inclination mechanism. The inclination mechanism inclines an inner periphery face to the rotation axis such that a position where acted centrifugal force due to a revolution about the revolution axis is maximum in the inner periphery face changes in an axial direction of the container as the container rotates about the rotation axis, and such that the crushing ball moves in a circumferential direction and the axial direction of the container to describe a trajectory of three dimensional Lissajous curve.

According this, the inner periphery of the container inclines to the rotation axis. Therefore, a position where centrifugal force acting due to the revolution about the revolution axis is maximum in the inner periphery face changes in an axial direction of the container as the container rotates.

As a result, the crushing ball moves in a circumferential direction and the axial direction of the container to describe a trajectory a three-dimensional Lissajous curve. Therefore, this causes the crushing ball to be agitated in the axial direction of the container, which improves crushability of the objects to be crushed.

### BRIEF DESCRIPTION OF THE DRAWINGS

In the accompanying drawings:

FIG. 1 is an elevation view showing a centrifugal ball mill according to a first embodiment;

FIG. 2 is a view viewed along the arrow A in FIG. 1;

FIG. 3 is a cross-section view of a container when the centrifugal ball mill according to the first embodiment is in operation;

FIG. 4 is a cross-section view of the container when the centrifugal ball mill according to the first embodiment is in operation;

FIG. 5 is a view of a trajectory of a crushing ball of the centrifugal ball mill according to the first embodiment;

FIG. 6 is a view of a trajectory of a crushing ball of the centrifugal ball mill according to the first embodiment;

FIG. 7 is a cross-section view of a centrifugal ball mill according to a second embodiment;

FIG. 8 is a cross-section view of a container when a the centrifugal ball mill according to a third embodiment is in operation;

FIG. 9 is a cross-section view of the container when the centrifugal ball mill according to the third embodiment is in operation, the centrifugal ball mill being rotated by 180 degrees from the position shown in FIG. 8;

FIG. 10 is a view of a trajectory of a crushing ball of the centrifugal ball mill according to the third embodiment;

FIG. 11 is an elevation view showing a main portion of a centrifugal ball mill according to a fourth embodiment;

FIG. 12 is a cross-section view of a container when a the centrifugal ball mill according to the fourth embodiment is in operation;

FIG. 13 is a cross-section view of the container when the centrifugal ball mill according to the fourth embodiment is in operation, the centrifugal ball mill being rotated by 180 degrees from the position shown in FIG. 12; and

FIG. 14 is a view of a trajectory of a crushing ball of the centrifugal ball mill according to the fourth embodiment.

### DETAILED DESCRIPTION OF THE PREFERRED EMBODIMENTS

### First Embodiment

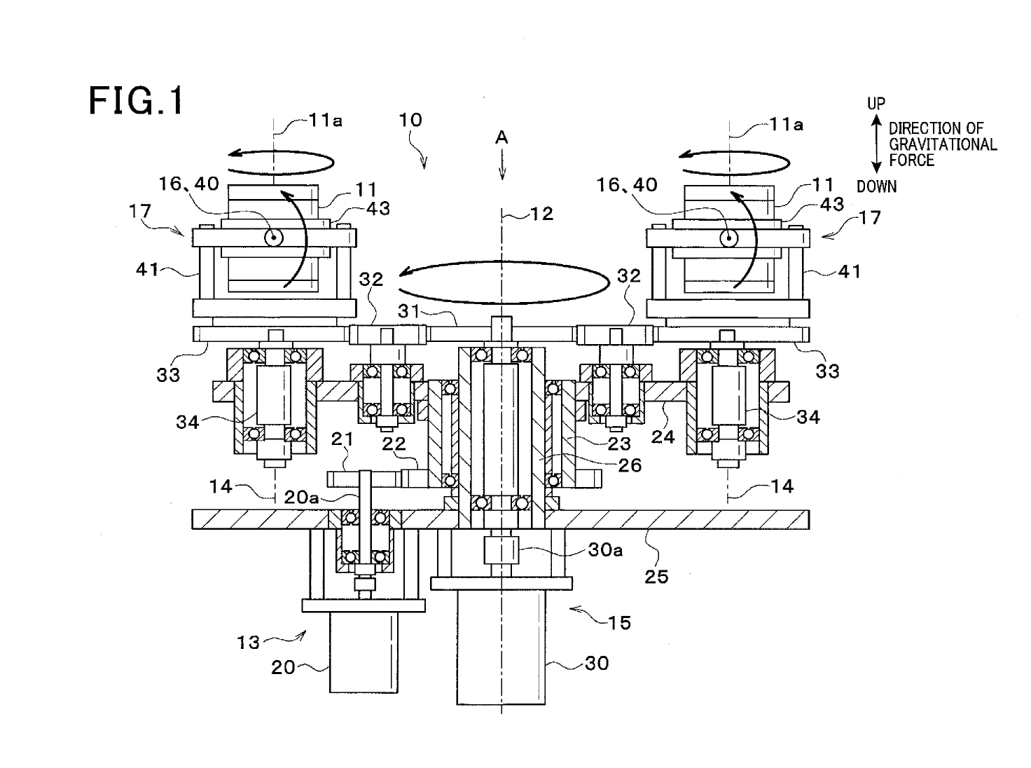

Hereinafter, the first embodiment is described, referring to FIGS. 1 to 6.

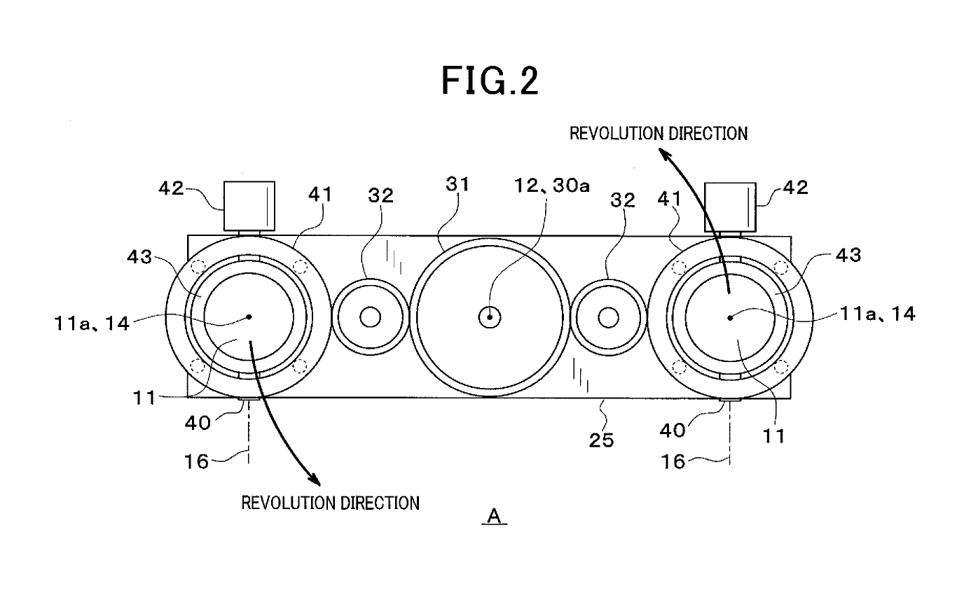

FIG. 1 is a elevation view of a centrifugal ball mill 10 according to the first embodiment, FIG. 2 is a view viewed along the arrow A in FIG. 1. FIG. 1 shows a cross-sectional view of a part of the ball mill 10. In FIG. 1, the up and down arrow shows an up-and-down direction along the direction of gravitational force.

The centrifugal ball mill 10 has a revolution mechanism (corresponds to a revolution means in the claims) 13, a rotation mechanism (corresponds to a rotation means in the claims) 15, and a swing mechanism 17. The revolution mechanism 13 revolves a container 11 about a revolution axis 12. The rotation mechanism 15 rotates the container 11 about a rotation axis 14. The swing mechanism 17 swings the container 11 about a swing axis 16. The swing mechanism 17 composes an adjustment portion that adjusts the attitude of the container 11, corresponds to the inclination mechanism in the claims or an inclination means.

In the example of FIGS. 1 and 2, the revolution axis 12 is parallel to the direction of gravitational force, and the rotational axis 14 is parallel to the revolution axis 12. The swing axis 16 is disposed along the rotational plane (revolutionary plane) of the revolution mechanism 13, in the state of FIGS. 1 and 2, is directed to the revolution direction of the container 11, i.e., directed to the tangential direction of the rotational trajectory (revolutionary trajectory) of the revolution mechanism 13. The rotational plane of the revolution mechanism 13 is a plane forming a circle which the revolutionary trajectory describes, in other words, a plane parallel to the revolution axis 12.

The revolution mechanism 13 has a revolution actuator 20, revolution gears 21, 22, a revolution shaft 23, and a revolution arm 24.

The revolution actuator 20 is fixed to a base member 25 such that its output shaft 20a is parallel to the revolution axis 12. The output shaft 20a of the revolution actuator 20 is connected to the cylindrical revolution shaft 23 through the revolution gears 21, 22.

In the example of FIGS. 1 and 2, the output shaft 20a of the revolution actuator 20 extends upward in the direction of gravitational force, and the revolution gears 21, 22 are disposed above the base member 25 in the direction of gravitational force.

A cylindrical revolution shaft support member 26 is coaxially inserted inside of the revolution shaft 23. The revolution shaft 23 is rotatably supported by the revolution shaft support member 26 through bearings. The revolution shaft support member 26 is fixed to the base member 25 to be coaxially with the revolution shaft 23. Therefore, the revolution shaft 23 can rotate about the revolution axis 12. In the example of FIGS. 1 and 2, the revolution shaft support member 26 extends from the base member 25 upward in the direction of gravitational force.

The revolution arm 24 is fixed to the revolution shaft support member 26, and extends radially-outward of the revolution shaft support member 26. The revolution arm 24 has a capacity to rotate about the revolution axis 12 integrally with the revolution shaft 23. In the example of FIGS. 1 and 2, the revolution arm 24 is disposed above the revolution gears 21, 22 in the direction of gravitational force.

The rotation mechanism 15 has a rotation actuator 30, rotation gears 31, 32, 33, and a rotation shaft 34.

An output shaft 30a of the rotation actuator 30 is inserted inside of the revolution shaft support member 26, and fixed to the base member 25 to be coaxial with the revolution axis 12. The output shaft 30a of the rotation actuator 30 is rotatably supported by the revolution shaft support member 25 through bearings.

The output shaft 30a of the rotation actuator 30 is connected to the rotation shaft 34 through the rotation gears 31, 32, 33. The rotation shaft 34 is rotatably supported by the revolution arm 24 through bearings rotatably and coaxially with the rotation axis 14. Therefore, the rotation shaft 34 can rotate about the rotation axis 14.

In the example of FIGS. 1 and 2, the output shaft 30a of the rotation actuator 30 extends upward in the direction of the gravitational force, the rotation gears 31, 32, 33 are disposed above the revolution arm 24.

The swing mechanism 17 has a swing shaft 40, a swing shaft support member 41, a swing actuator 42 and a container fixing member 43. The swing shaft 40 is supported by the swing shaft support member 41 swingably and coaxially with the swing axis 16. Therefore, the swing shaft 40 can swing about the swing axis 16.

The swing shaft 40 is connected to an output shaft (not shown in the drawings) of the swing actuator 42. The swing actuator 42 is fixed to the swing shaft support member 41. The swing shaft support member 41 is fixed to the rotation shaft 34. Therefore, the swing shaft support member 41 can rotate about the rotation axis 14.

The container fixing member 43, which is cylindrical, is fixed to the swing shaft 40. Therefore, the container fixing member 43 can swing about the swing axis 16 integrally with the swing shaft 40.

In the example of FIGS. 1 and 2, the swing shaft 40, the swing shaft support member 41 and the container fixing member 43 are disposed over the rotation gears 31, 32, 33.

The cylindrical container 11 is inserted and fixed into the container fixing member 43. In this example, the container 11 has a circular-cylindrical shape whose cross-section is circular. It is not limited to having a circular-cylindrical but may be non-circular cylindrical. For example, the container 11 may have a polygonal-cylindrical shape whose cross-section is polygonal, or the cross-section of the container 11 may have a non-circular closed curve.

The container 11 is fixed to the container fixing member 43 such that its center axis 11a (also described as container center axis below) is perpendicular to the swing axis 16. The container 11 is fixed such that its gravity center is disposed on the swing axis 16. Therefore, the container 11 can swing about the gravity center as a center of rotation around the swing axis 16.

In the example of FIGS. 1 and 2, a pair of the rotation mechanisms 15 and the swing mechanisms 17 are provided, therefore, two containers 11 can be fixed at the same time.

The actuation in the above described configuration is described. When the revolution actuator 20 is actuated, the rotational force of the output shaft 20a of the actuator 20 is transmitted to the revolution arm 24 through the revolution gears 21, 22 and the revolution shaft 23, which rotates the revolution arm 24 about the revolution axis 12.

The rotation of the revolution arm 24 about the revolution axis 12 revolves the rotation shaft 34 supported by the revolution arm 24 about the revolution axis 34. The revolution of the rotation shaft 34 about the revolution axis 12 rotates the rotation shaft 34 about the rotation axis 14 through the engagement of the rotation gears 31, 32, 33 connected to the rotation shaft 34.

Therefore, the container 11 connected to the rotation shaft 34 through the swing shaft support member 41, the swing shaft 40 and the container fixing member 43 revolves about the revolution axis 12 and rotates about the rotation axis 14.

At this time, if the rotation actuator 30 is actuated, the rotational force of the output shaft 30a of the rotation actuator 30 is transmitted to the rotation shaft 34 through the rotation gears 31, 32, 33. For this, the rotational speed changes, this changes the rotational speed of the container 11.

At a specified rotational speed of the output shaft 30a of the rotation actuator 30 depending on the gear ratio of the revolution gears 21, 22 and the rotation gears 31, 32, 33, the rotation of the rotation shaft 34 driven by the rotation actuator 30 and the rotation of the rotation shaft 34 driven by the revolution actuator 20 are balanced, which stops the rotation of the rotation shaft 34, as a result, the rotation of the container 11 stops.

When the swing actuator 42 is actuated, the swinging force of the output shaft of the swing actuator 42 is transmitted to the container fixing member 43 through the swing shaft 40, the container 11 fixed to the container fixing member 43 swings about the swing axis 16.

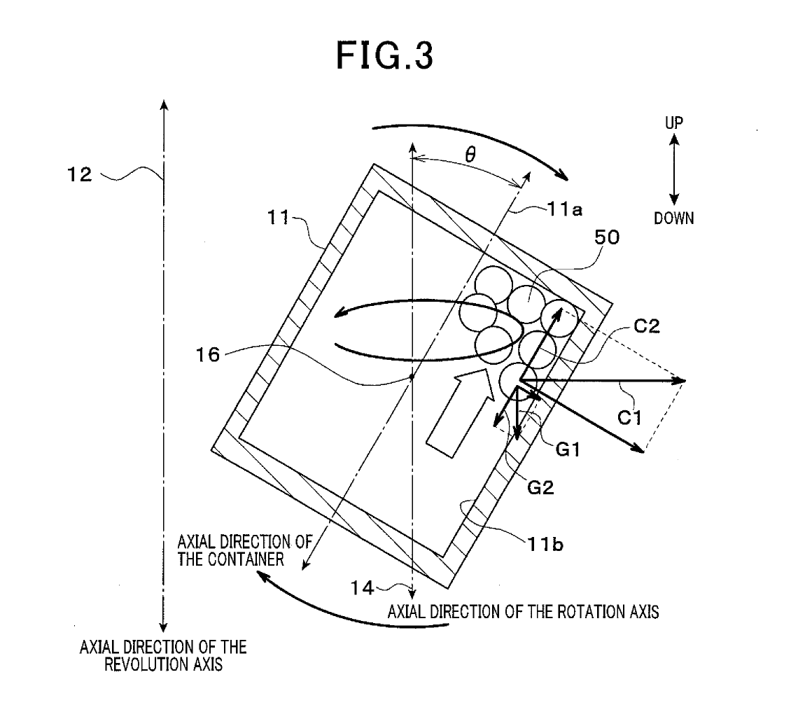

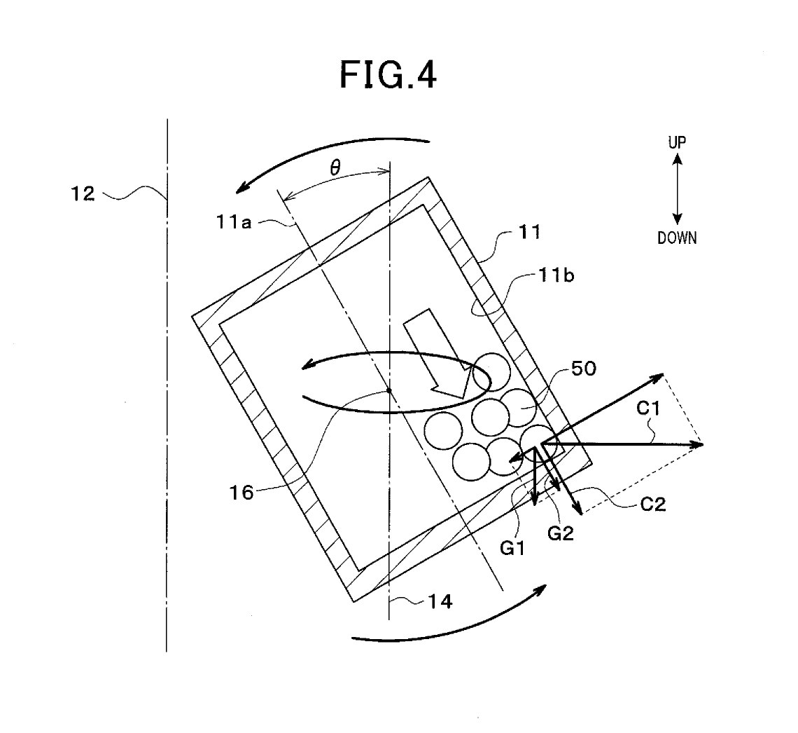

As shown in FIGS. 3 and 4, swinging of the container 11 about the swing axis 16 changes an inclination angle θ of the container center axis 11a to the rotation axis 14. For this, an inner periphery face 11b can be inclined to the rotation axis 14.

When the inner periphery face 11b of the container 11 inclines to the rotation axis 14, the part farthest away from the revolution axis 12 in the inner periphery face 11b of the container 11 changes along the direction of the container center axis 11a (the axial direction of the container 11), as the container 11 rotates about the rotation axis 14. For this, the position (described as a maximum centrifugal force position) where the centrifugal force due to the revolution is maximum in the inner periphery face 11b of the container 11 changes along the direction of the container center axis 11a.

In the state shown in FIG. 3, the container 11 inclines to a direction where its top is further away from the revolution axis 12 than its bottom is (i.e. toward right side in FIG. 3). Therefore, a top portion (neighborhood of the upper right corner portion of the container 11 in FIG. 3) of the inner periphery face 11b of the container 11 is farthest away from the revolution axis 12 in the inner periphery face 11b of the container 11, the top portion becomes the maximum centrifugal force position.

In the state shown in FIG. 4, the container 11 inclines to a direction where its bottom is further away from the revolution axis 12 than its top is (i.e. toward right side in FIG. 4). Therefore, a bottom portion (neighborhood of the lower right corner portion of the container 11 in FIG. 4) of the inner periphery face 11b of the container 11 is farthest away from the revolution axis 12, the top portion becomes the maximum centrifugal force position.

At this time, the crushing balls 50 move upward and downward along the axial direction (described as the container center axial direction, below) of the container center axis 11a depending on the sum of the container center axial direction component C2 of the centrifugal force C1 due to the revolution and the container center axial direction component G2 of the gravitational force G1 acting on the crushing balls 50. As a result, the crushing balls collect at the maximum centrifugal force position. Therefore, the crushing bails move upward and downward along the container center axial direction, as the maximum centrifugal force position changes along the container center axial direction.

The balance of the container center axial direction component C2 of the centrifugal force C1 and the container center axial direction component G2 of the gravitational force G1 changes, as the inclination angle θ of the container center axis 11a to the rotation axis 14 changes. For this, the crushing ball 50 moves upward and downward along the container center axial direction.

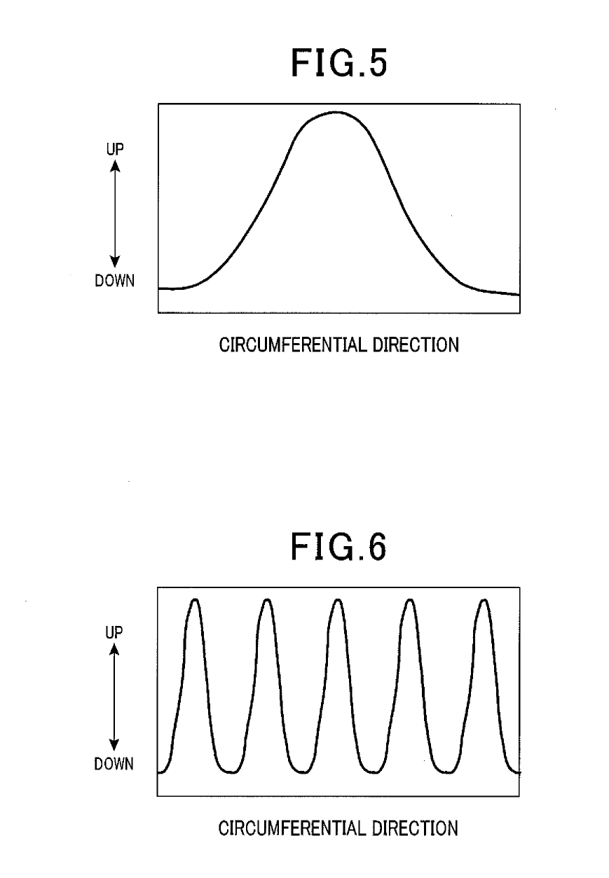

According to this embodiment, the crushing ball 50 moves in the axial direction and circumferential direction of the container 11, so that it describes a trajectory of a three dimensional Lissajous curve. FIGS. 5 and 6 show the trajectories of the crushing ball 50 on the inner periphery face 11b with the inner periphery face 11b unfolded into a plane. The trajectories in FIGS. 5 and 6 are two dimensional Lissajous figures. The Lissajous curve is a complex curve of two simple harmonic motions, the two simple harmonic motions being orthogonal to each other.

FIG. 5 shows a trajectory of the crushing ball 50 when the container 11 is swung within a predetermined angle once during one rotation of the container 11. The crushing ball 50 describes a trajectory such as a SIN curve. For this, the crushing ball 50 and the object to be crushed in the container 11 are agitated upward and downward along the container center axial direction, which can increases crushability of the object to be crushed.

FIG. 6 shows a trajectory of the crushing ball 50 when the container 11 is swung within a predetermined angle at five times during one rotation of the container 11. Like this, if the swinging number to the rotation number is increased, the period of the SIN curve is shortened, and the number of the upward and downward agitations of the crushing ball 50 and the object to be crushed is increased. For this, crushability of the object to be crushed can be increased further.

By controlling the actuation of the rotation actuator 30 during the crushing process to increase or decrease the rotational speed of the container 11, or to invert the rotational direction of the container 11, the trajectory of the crushing ball 50 can be arbitrarily changed. Specifically, the trajectory of the crushing ball 50 can be changed to various trajectories except for the trajectory like SIN curve, for example, a linear trajectory, a circular trajectory or a trajectory like a helix. Therefore, crushability of the object to be crushed can be arbitrarily regulated depending on materials of the object to be crushed or target degree of crush.

In this embodiment, the balance of the components C2 and G2 of the force acting on the crushing ball 50 can be changed effectively, because the container 11's gravity center is disposed on the swing axis 16.

### Second Embodiment

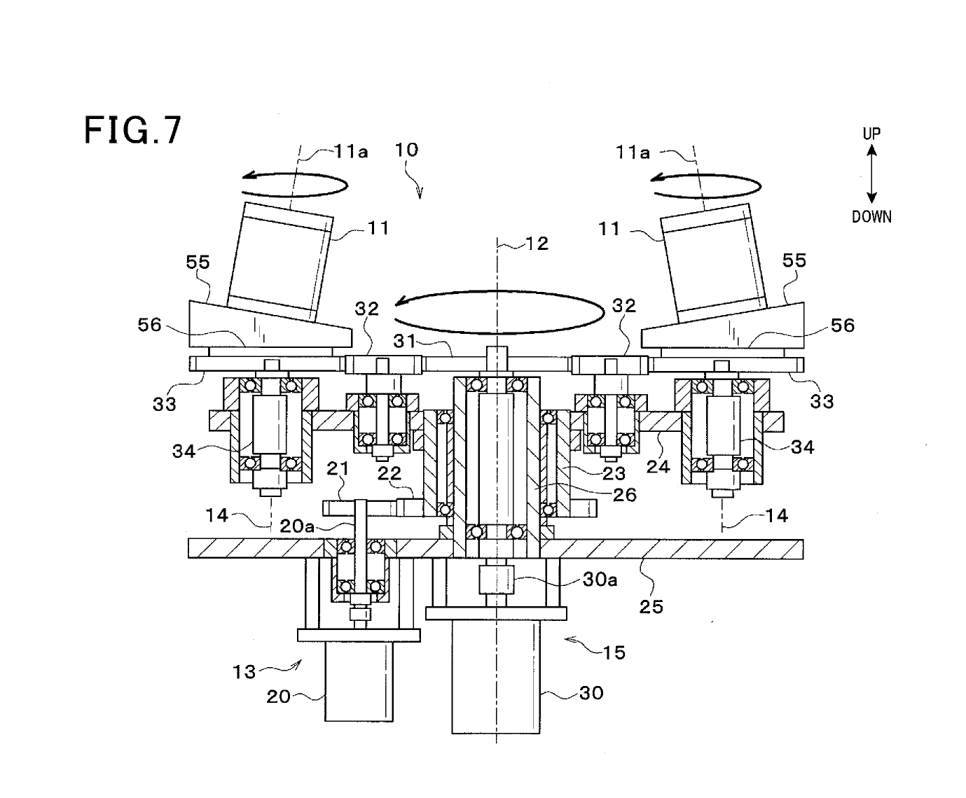

Next, a second embodiment according to the present invention is described, referring to FIG. 7. The same reference symbols are used for the elements corresponding to the elements of the first embodiment.

In the above-described first embodiment, swinging the container 11 by the swing shaft 40 changes the inclination angle θ of the container center axis 11a to the rotation axis 14. On the other hand, in the second embodiment, as shown in FIG. 7, the inclination angle θ of the container center axis 11a to the rotation axis 14 is changed by using an angle adjuster 55 for fixing the container 11.

Specifically, a flat-plate container fixing member 56 is fixed to the rotation shaft 34. The angle adjuster 55 is disposed between the container fixing member 56 and the container 11, and the container 11 is fixed to the container fixing member 56 through the angle adjuster 55 with the inner periphery of the container 11 inclined to the rotation axis 14. The container 11 rotates about the rotation axis 14 and revolves about the revolution axis 12 with the container 11 inclined to the rotation axis 14 at the predetermined angle. The container fixing member 56 and the angle adjuster 55 are located superior to the rotation gears 31, 32, 33 in the direction of gravitational force.

The angle adjuster 55 has a shape inclined at a predetermined angle configured such that the container 11 inclines to the container fixing member 56 at a predetermined angle. For this, the container 11 can be inclined to the rotation axis 14. In the example of FIG. 7, the angle adjuster 55 has an inclination face that inclines to a fixing face of the container fixing member 56, and the container 11 is disposed on the inclination face. In the example of FIG. 7, the container 11 inclines to the rotation axis such that its lower side is further away from the revolution axis than its upper side.

The inner periphery face 11b of the container 11 inclines to the rotation axis 14, because the container 11 inclines to the rotation axis 14. Therefore, the inclination angle of the inner periphery face 11b of the container 11 to the revolution axis 12 changes as the container 11 rotates, which causes the maximum centrifugal force position in the inner periphery face 11b of the container 11 to move along the container center axial direction.

In this embodiment, the crushing ball 50 moves in the circumferential direction and the axial direction of the container 11, as a result, describes a trajectory of a three dimensional Lissajous curve. The crushing ball 50 describes a trajectory such as a SIN curve in the inner periphery 11b of the container 11. As a result, the crushing ball 50 and the object to be crushed are agitated upward and downward along the container center axial direction, which can increases crushability for the object to be crushed.

The inclination angle θ can be changed by preparing a plurality of angle adjusters 55 different in inclination and replacing the angle adjuster 55. The trajectory of the crushing ball 50 can be arbitrarily changed by changing the inclination angle, the rotational speed of the container 11, or by inverting the rotational direction of the container 11.

### Third Embodiment

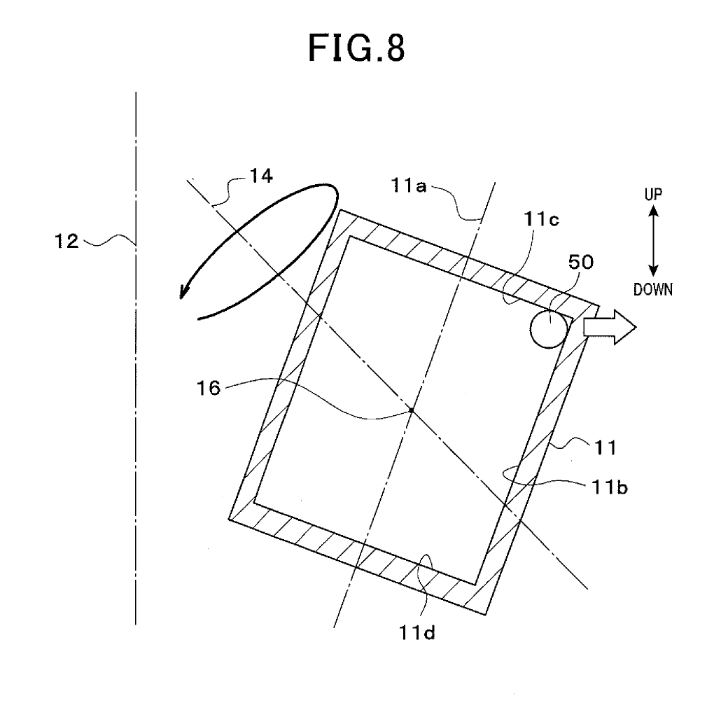

Next, a third embodiment according to the present invention is described, referring to FIGS. 8 to 10. The same reference symbols are used for the elements corresponding to the elements of the first embodiment.

In the above-described embodiment, the rotation axis 14 is parallel to the revolution axis 12, on the other hand, in the third embodiment, as shown in FIG. 8, the rotation axis 14 is non-parallel to the revolution axis 14. The angle of the container center axis 11a to the rotation axis 14 is constant.

The rotation axis 14 inclines to the revolution axis 12 at 45 degrees. The container center axis 11a is non-parallel to the rotation axis 14. Therefore, the inner periphery face 11b of the container 11 inclines to the rotation axis 14.

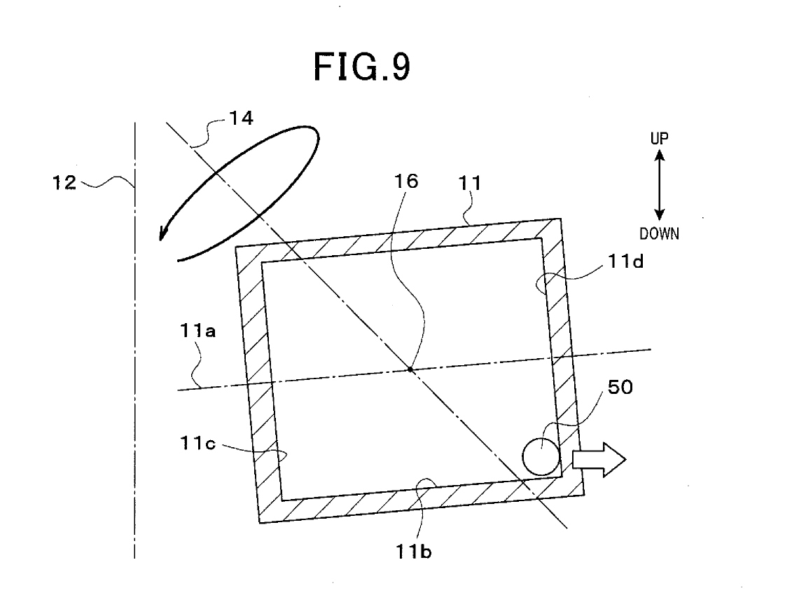

If the container 11 rotates from an attitude shown in FIG. 8 by 180 degrees, the attitude of the container 11 changes as shown in FIG. 9. In the state of FIG. 8, a first end (one end in the container center direction, which is closer to the top 11c of the container 11 than to the bottom 11d of the container 11) in the inner periphery face 11b is farthest away from the revolution axis 12. In the state of the FIG. 9, a second end (the other end in the container center direction, which is closer to the bottom 11d of the container 11 than to the top 11c of the container 11) is farthest away from the revolution axis 12.

Thus, like the above-described embodiment, the maximum centrifugal force position moves along the container center axis 11a, as the container 11 rotates.

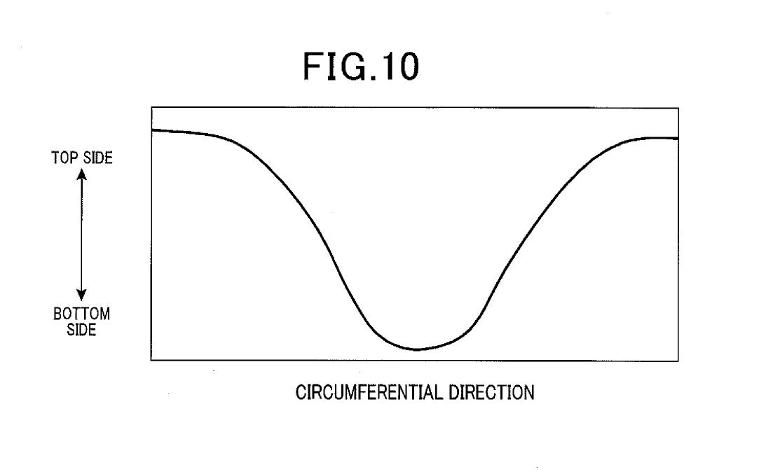

According to this embodiment, the crushing ball 50 moves in the circumferential direction and the axial direction of the container 11, as a result, describes a trajectory of a three dimensional Lissajous curve. When the inner periphery face 11b of the container 11, on which the trajectory of the crushing ball 50 at this time is described, is unfolded, the trajectory on the unfolded inner periphery 11b becomes a two dimensional Lissajous figure (a trajectory such as a SIN curve) as shown in FIG. 10. Therefore, this embodiment can perform actions and effects similar to the above-described embodiments.

### Fourth Embodiment

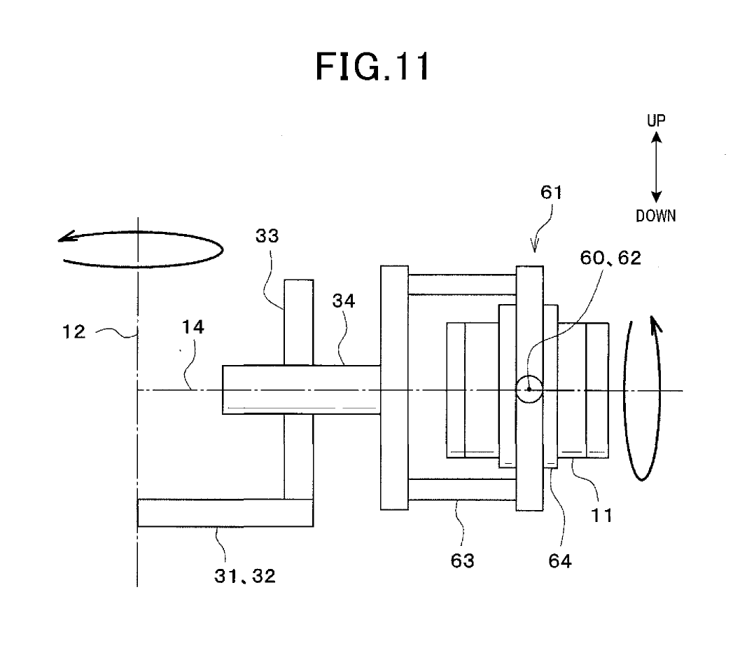

Next, a fourth embodiment according to the present invention is described, referring to FIGS. 11 to 14. The same reference symbols are used for the elements corresponding to the elements of the first embodiment.

In the above-described third embodiment, the rotation axis 14 inclines to the revolution axis 12 at 45 degrees, on the other hand, in the fourth embodiment, as shown in FIG. 11, the rotation axis 14 inclines to the revolution axis 12 at 90 degrees.

In the example of FIG. 11, the rotation gears 31, 32, 33 which transmit the rotational force from the output shaft 20a (not shown in FIG. 11) of the rotation actuator 30 to the rotation shaft 34 changes the rotational direction by 90 degrees.

The centrifugal ball mill 10 according to this embodiment has a second rotation mechanism 61 that rotates the container 11 about a rotation axis 60. The second rotation mechanism 61 composes an adjustment portion that adjusts an inclination angle of the container 11 to the rotation axis 14, and corresponds to the inclination mechanism in the claims or an inclination means. In FIG. 11, the rotation axis 60 is directed to the revolution direction of the container 11. The rotation axis 60 is disposed such that the rotational plane of the second rotation mechanism 61 crosses the rotation axis 14 of the rotation mechanism 15, and such that the rotational plane of the second rotation mechanism 61 faces the revolution axis 12.

The second rotation mechanism 61 has a rotation shaft 62, a rotation shaft support member 63, a rotation actuator (not shown), and a container fixing member 64. The rotation shaft 62 is supported by the rotation shaft support member 63 rotatably and coaxially with the rotation axis 60. Therefore, the rotation shaft 62 can rotate about the rotation axis 60.

The rotation shaft 62 is connected to an output shaft (not shown) of the rotation actuator. The rotation actuator is fixed to the rotation shaft support member 63. The rotation shaft support member 63 is fixed to the rotation gear 33. Therefore, the rotation shaft support member 63 can rotate about the rotation axis 14.

The container fixing member 64 has a circular-cylindrical shape, and it is fixed to the rotation shaft 62. Therefore, the container fixing member 64 can rotate about the rotation axis 60 integrally with the rotation shaft 62. The container fixing member 64 is configured such that the circular-cylindrical container 11 is inserted and fixed into the container fixing member 64.

The container 11 is fixed to the container fixing member 64 such that the center axis 11a of the container 11 is perpendicular to the rotation axis 60. The container 11 is fixed to the container fixing member 64 such that the gravity center of the container 11 is disposed on the rotation axis 60. Therefore, the container 11 can rotate about the gravity center as a center of rotation around the rotation axis 60.

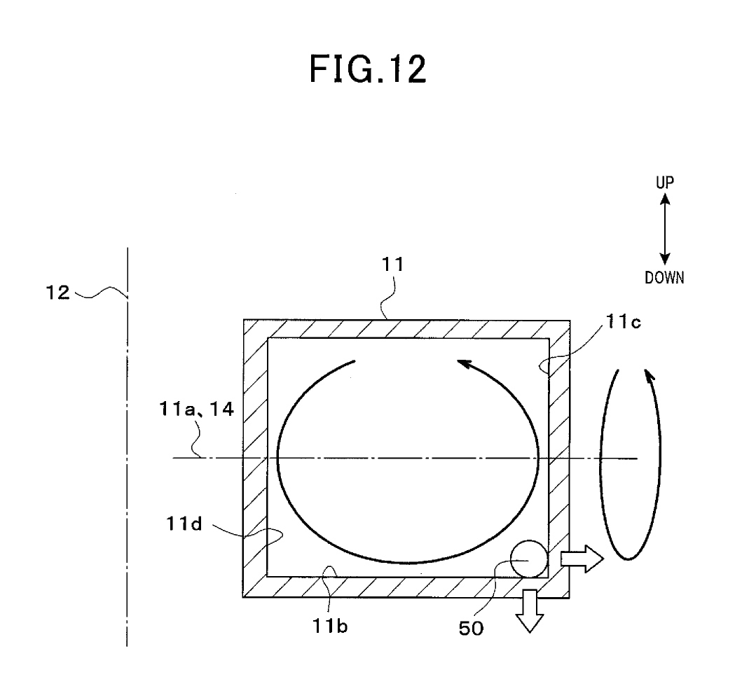

The rotation actuator (not shown) of the second rotation mechanism 61 rotates the rotation shaft 62 with the same period as the rotation about the rotation axis 14. Therefore, the container 11 rotates about the rotation axis 60 with the same period as the rotation about the rotation axis 14. In other words, the container center axis 11a rotates in a radial direction (right-and-left direction in FIG. 12) of the revolutionary plane with the same period as the rotation about the rotation axis 14.

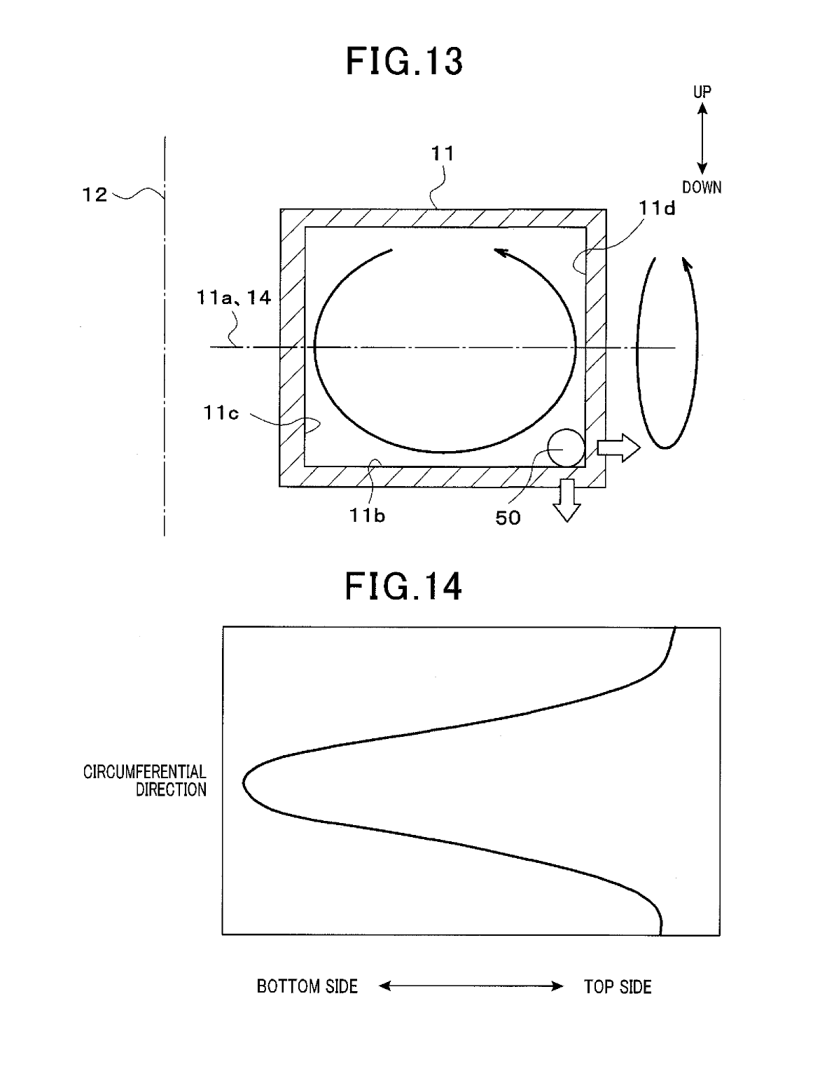

When the container 11 (the container center axis 11a) rotates about the rotation axis 14 an attitude shown in FIG. 12 by 180 degrees, the container 11 rotates also about the rotation axis 60 of the second rotation mechanism 61. For this, the inclination angle of the container 11 to the rotation axis 14 changes, until the direction of the container 11 (the container center axis 11a) is inverted as shown in FIG. 13. Therefore, the maximum centrifugal force position in the inner periphery face 11b of the container 11 changes along the direction of the container center axis 11a (the axial direction of the container 11), because the inclination angle of the inner periphery face 11b of the container 11 to the revolution axis 12 changes.

In the state of FIG. 12, a first end (one end in the container center direction, which is closer to the top 11c of the container 11 than to the bottom 11d of the container 11) in the inner periphery face 11b of the container 11 is farthest away from the revolution axis 12, therefore the top 11c is the maximum centrifugal force position. In the state of FIG. 13, a second end (one end in the container center direction, which is closer to the bottom 11d of the container 11 than to the top 11c of the container 11) in the inner periphery face 11b of the container 11 is farthest away from the revolution axis 12, therefore the bottom 11d is the maximum centrifugal force position.

Therefore, like the above-described embodiments, the crushing ball 50 moves along the direction of the container center axis 11a, as the rotation of the container 11 moves the maximum centrifugal force position along the direction of the container center axis 11a.

According to this embodiment, the crushing ball 50 moves in the circumferential direction and the axial direction of the container 11, as a result, describes a trajectory of a three dimensional Lissajous curve. When the inner periphery 11b of the container 11, on which the trajectory of the crushing ball 50 at this time is described, is unfolded, the trajectory on the unfolded inner periphery 11b becomes a two dimensional Lissajous figure (a trajectory such as a SIN curve) as shown in FIG. 14. Therefore, this embodiment can perform actions and effects similar to the above-described embodiments.

### Other Embodiments

Though the invention has been described with respect to the specific preferred embodiments, many variations and modifications will become apparent to those skilled in the art upon reading the present application. It is therefore the intention that the claims be interpreted as broadly as possible in view of the prior art to include all such variations and modifications.

(1) For example, in the above-described first embodiment, the swing axis 16 is disposed on the revolutionary plane. The present invention is not limited to this, and the swing axis 16 only has to be non-parallel to the rotation axis 14. By contraries, rotational speed may be regulated to keep the attitude of the swing axis 16 directed to the revolution direction.

In the above-described first embodiment, the revolution axis 12 is parallel to the direction of gravitational force, and the rotation axis 14 is parallel to the revolution axis 12. The present invention is not limited to this. For example, the revolution axis 14 may be substantially parallel to the direction of gravitational force, and the rotation axis 14 may be substantially parallel to the revolution axis 12.

(2) In the above-described first embodiment, the swing shaft 40 is automatically swung by the swing actuator 42. However, swinging the swing shaft 40 is not necessarily limited to automatically swinging by using the swing actuator 42.

For example, the revolution actuator 20 and rotation actuator 30 may be once stopped once at a constant period during the crushing process, the angle of the swing shaft 40 may be manually changed, after that, the revolution actuator 20 and the rotation actuator 30 may be operated again.

(3) In the above-described second embodiment, the container 11 and the angle adjuster 55 are individual members, but they may be formed as a unit.

(4) In the above-described embodiments, the swing shaft 40 and the angle adjuster 55 are used for inclining the container 11 to the rotation axis 14. The present invention is not limited to this, for example, the container 11 may be inclined to the rotation axis 14 by using a jack. That is to say, an angle adjuster 55 having a means capable of changing the inclination angle without replacing the angle adjuster 55 itself, for example a jack capable of changing the fixing height of a part of the bottom of the container 11 to change the inclination angle of the container 11, may be used.

(5) In the above-described embodiments, a pair of rotation mechanisms 15 are provided, and two containers 11 can be fixed to them at the same time. The present invention is not limited to this, the number of the rotation mechanisms 15 may be increased or decreased.

What is claimed is:

1. A centrifugal ball mill, comprising:
a cylindrical container in which an object to be crushed and a crushing ball are contained;
a revolution means for revolving the container about a revolution axis;
a rotation means for rotating the container about a rotation axis; and
an inclination mechanism that inclines an inner periphery face relative to the rotation axis such that a position where centrifugal force acting due to revolution about the revolution axis is maximum in the inner periphery face changes in an axial direction of the container as the container rotates about the rotation axis, and such that the crushing ball moves in a circumferential direction and the axial direction of the container to describe a trajectory of a three dimensional Lissajous curve.

2. The centrifugal ball mill according to claim 1, wherein
the inclination mechanism has a capacity to change an angle of the container to the rotation axis.

3. The centrifugal ball mill according to claim 2, wherein
the inclination mechanism is configured to swing the container about a swing axis which is non-parallel to the rotation axis.

4. The centrifugal ball mill according to claim 3, wherein
the swing axis is disposed on a gravity center of the container.

5. The centrifugal ball mill according to claim 4, wherein
the swing axis is disposed along a rotational plane of the revolution means.

6. The centrifugal ball mill according to claim 2, wherein
the inclination mechanism is an adjuster that adjusts the angle of the container to the rotation axis.

7. The centrifugal ball mill according to claim 2, wherein
the rotation axis is disposed to be non-parallel to the revolution axis.
